(19) United States
(12) Patent Application Publication
(10) Pub. No.: US 2024/0112002 A1
(43) Pub. Date: Apr. 4, 2024

(54) NEUROMORPHIC INTERFACE CIRCUIT AND OPERATING METHOD THEREOF AND NEUROMORPHIC INTERFACE SYSTEM

(71) Applicant: Electronics and Telecommunications Research Institute, Daejeon (KR)

(72) Inventors: Sung Eun KIM, Daejeon (KR); Tae Wook KANG, Daejeon (KR); Hyuk KIM, Daejeon (KR); Young Hwan BAE, Daejeon (KR); Kyung Jin BYUN, Daejeon (KR); Kwang IL OH, Daejeon (KR); Jae-Jin LEE, Daejeon (KR); In San JEON, Daejeon (KR)

(73) Assignee: Electronics and Telecommunications Research Institute, Daejeon (KR)

(21) Appl. No.: 18/344,275

(22) Filed: Jun. 29, 2023

(30) Foreign Application Priority Data
Sep. 29, 2022 (KR) 10-2022-0124600
Jan. 6, 2023 (KR) 10-2023-0002101

(51) Int. Cl. G06N 3/049; G06N 3/063

(52) U.S. Cl. CPC G06N 3/049; G06N 3/063

(57) ABSTRACT

Disclosed is an interface system including a first neuron cluster that outputs a first neuron signal including a first neuron request and first neuron data by performing a first arithmetic operation, and a first interface circuit that stores the first neuron data and outputs a first response, in response to the first neuron request. The first neuron cluster outputs a second neuron signal including a second neuron request and second neuron data by performing a second arithmetic operation, in response to the first response. Before the first data is transmitted to a second neuron cluster different from the first neuron cluster, the first interface circuit outputs the first response in response to a fact that the first neuron data is stored.

### CROSS-REFERENCE TO RELATED APPLICATIONS

This application claims priority under 35 U.S.C. § 119 to Korean Patent Application No. 10-2023-0002101 filed on Jan. 6, 2023 and No. 10-2022-0124600 filed on Sep. 29, 2022, in the Korean Intellectual Property Office, the disclosures of which are incorporated by reference herein in their entireties.

### BACKGROUND

Embodiments of the present disclosure described herein relate to an interface system, and more particularly, relate to a neuromorphic interface circuit, an operating method thereof, and a neuromorphic interface system.

A neuromorphic network circuit refers to one of methods of implementing an artificial intelligence network that performs a network operation on an input and then outputs an output. An interface circuit having low power and high speed is essential because the neuromorphic circuit delivers numerous parallel operations to an external circuit.

Parallel signals obtained from the parallel operation of the neuromorphic circuit may not be delivered at once due to hardware resource constraints. Accordingly, because the parallel signals are serialized, the parallel signals may be only delivered through interface circuits in chronological order. Accordingly, a bottleneck may occur in the entire neuromorphic interface system, and an error may occur in the calculation result of the neuromorphic circuit.

### SUMMARY

Embodiments of the present disclosure provide a neuromorphic interface circuit that consumes low power and operates at high speed by using a memory-based neuromorphic interface system, an operating method thereof, and a neuromorphic interface system.

According to an embodiment, a neuromorphic interface system includes a first neuron cluster that outputs a first neuron signal including a first neuron request and first neuron data by performing a first arithmetic operation, and a first interface circuit that stores the first neuron data and outputs a first response, in response to the first neuron request. The first neuron cluster outputs a second neuron signal including a second neuron request and second neuron data by performing a second arithmetic operation, in response to the first response. Before the first data is transmitted to a second neuron cluster different from the first neuron cluster, the first interface circuit outputs the first response in response to a fact that the first neuron data is stored.

In an embodiment, the first interface circuit is further configured to output a first transmission signal including a first transmission request and first transmission data by performing a first transmission operation, and to output the first transmission signal after outputting the first response.

In an embodiment, the first neuron cluster includes a plurality of neuron circuits and a plurality of synaptic circuits. The first neuron signal is a signal generated as a first neuron circuit among the plurality of neuron circuits fires.

In an embodiment, the first interface circuit includes a first memory device. The first memory device is enabled based on the first neuron request. When the first memory device is enabled, the first neuron data is stored in the first memory device.

In an embodiment, the system further includes a second interface circuit that stores the first transmission data and outputs a second response, in response to the first transmission request. The first interface circuit is configured to output a second transmission signal including a second transmission request and second transmission data by performing a second transmission operation, in response to the second response. Before the first transmission data is transmitted to the second neuron cluster, the second interface circuit outputs the second response in response to a fact that the first transmission data is stored.

In an embodiment, the second interface circuit is further configured to output a first routing signal including a first routing request and first routing data by performing a first routing operation, and to output the first routing signal after outputting the second response.

In an embodiment, the second interface circuit further includes a second memory device.

The second memory device is enabled based on the first transmission request. When the second memory device is enabled, the first transmission data is stored in the second memory device.

In an embodiment, the system further includes a third interface circuit that stores the first routing data and outputs a third response, in response to the first routing request. The second interface circuit is configured to output a second routing signal including a second routing request and second routing data by performing a second routing operation, in response to the third response. Before the first routing data is transmitted to the second neuron cluster, the third interface circuit outputs the third response in response to a fact that the first routing data is stored.

In an embodiment, the third interface circuit is further configured to output a first reception signal including a first reception request and first reception data by performing a first reception operation, to output the first reception signal after outputting the third response.

In an embodiment, the third interface circuit includes a third memory device. The third memory device is enabled based on the first routing request. When the third memory device is enabled, the first routing data is stored in the third memory device.

In an embodiment, the first interface circuit is a transmission interface circuit for delivering information included in the first neuron signal to the second neuron cluster. The second interface circuit is a router circuit for selecting a path for delivering the information included in the first neuron signal to the second neuron cluster, and the third interface circuit is a reception interface circuit that receives the information included in the first neuron signal and delivers the information to the second neuron cluster.

In an embodiment, each of the first to third interface circuits operates in an asynchronous manner.

According to an embodiment, an interface circuit that receives a first input signal including a first request and first input data from a first circuit and transmits an output signal to a second circuit includes a memory device that stores first input data included in the first input signal, and outputs a first response for requesting a second input signal following the first input signal to the first circuit, and a processing unit that generates the output signal based on the first input data stored in the memory device and a second response transmitted from the second circuit. Before the output signal is generated, the memory device is further configured to output the first response.

In an embodiment, the interface circuit further includes an inverter element that receives the second response and outputs an inverted second response obtained by inverting the second response, and a muller-C element connected to an output terminal of the inverter element and a first output terminal of the memory device and outputting a processing enable signal based on the first response and the inverted second response. The memory device is further configured to transmit the first response to the first circuit and the muller-C element through the first output terminal and to transmit the first input data thus stored, to the processing unit through a second output terminal. The processing unit is connected to an output terminal of the muller-C element and the second output terminal of the memory device, and is enabled based on the processing enable signal to generate the output signal.

In an embodiment, the interface circuit further includes an inverter element that receives a second response from the second circuit and outputs an inverted second response obtained by inverting the second response, a muller-C element connected to an output terminal of the inverter element and a first output terminal of the memory device and outputting a clock enable signal based on the first response and the inverted second response, and a local clock generator connected to an output terminal of the muller-C element and outputting a local clock signal based on the clock enable signal. The memory device is further configured to transmit the first response to the first circuit and the muller-C element through the first output terminal and to transmit the first input data thus stored, to the processing unit through a second output terminal. The processing unit is connected to an output terminal of the local clock generator and the second output terminal of the memory device and is further configured to output the output signal based on the local clock signal.

According to an embodiment, an operating method of an interface circuit including a memory device and mediating communication between a first circuit and a second circuit includes receiving a first input signal from the first circuit, storing input data, which is included in the first input signal, in the memory device and transmitting a first response to the first circuit, determining a state of the second circuit based on a second response transmitted from the second circuit, and generating an output signal based on the state of the second circuit.

In an embodiment, the first circuit includes one or more neuron circuits. The first input signal is a signal generated as a first neuron circuit among the one or more neuron circuits fires.

In an embodiment, the first response is a signal for requesting the first circuit to generate a second input signal following the first input signal.

### BRIEF DESCRIPTION OF THE FIGURES

The above and other objects and features of the present disclosure will become apparent by describing in detail embodiments thereof with reference to the accompanying drawings.

FIG. 1 is a diagram showing a neuromorphic interface system.

FIG. 2 is a diagram showing an operation flow of the neuromorphic interface system of FIG. 1.

FIG. 3 is a diagram showing a neuromorphic interface system, according to an embodiment of the present disclosure.

FIG. 4 is a diagram showing an operation flow of the neuromorphic interface system of FIG. 3.

FIG. 5 is a circuit diagram illustrating an example of a part of the transmission interface circuit of FIG. 3.

FIG. 6 is a circuit diagram illustrating an example of a part of the transmission interface circuit of FIG. 3.

FIG. 7 is a circuit diagram illustrating another example of a part of the transmission interface circuit of FIG. 6.

FIG. 8 is a circuit diagram for describing another example of a part of the transmission interface circuit of FIG. 5.

FIG. 9 is a flowchart illustrating an operating method of a neuromorphic interface circuit, according to an embodiment of the present disclosure.

### DETAILED DESCRIPTION

Hereinafter, embodiments of the present disclosure will be described in detail and clearly to such an extent that an ordinary one in the art easily implements the present disclosure. In the description below, the terms “block”, “unit”, “module”, etc. or components corresponding to the terms may be implemented in the form of software, hardware, or a combination thereof.

In the following drawings or in the detailed description, modules may be connected with any other components except for components illustrated in a drawing or described in the detailed description. Modules or components may be connected directly or indirectly. Modules or components may be connected through communication or may be physically connected.

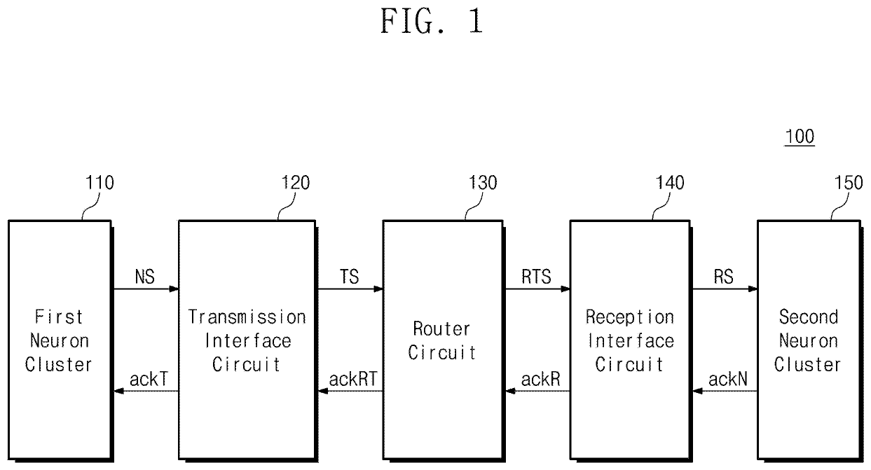

FIG. 1 is a diagram showing a neuromorphic interface system. Referring to FIG. 1, a neuromorphic interface system 100 may include a first neuron cluster 110, a transmission interface circuit 120, a router circuit 130, a reception interface circuit 140, and a second neuron cluster 150.

Each of the first neuron cluster 110 and the second neuron cluster 150 may be a neural network circuit including a plurality of neuron circuits (not shown) and a plurality of synaptic circuits (not shown). For example, each of the plurality of neuron circuits of the first neuron cluster 110 may receive signals to which a weight is applied by each of the plurality of synaptic circuits. Each of the plurality of neuron circuits may couple the received signals. Each of the plurality of neuron circuits may fire when the intensity of the coupled signal is greater than a predetermined threshold and may generate a neuron signal NS. The first neuron cluster 110 may transmit the neuron signal NS to the transmission interface circuit 120.

The neuron signal NS generated by each of the plurality of neuron circuits may be transmitted to the transmission interface circuit 120 depending on the generated time order. For example, when a first neuron signal NS1 is generated by the first neuron cluster 110, the first neuron cluster 110 may transmit the first neuron signal NS1 to the transmission interface circuit 120. Afterward, when the first neuron cluster 110 receives a transmission response ackT from the transmission interface circuit 120, the first neuron cluster 110 may generate a second neuron signal NS2 and may transmit the second neuron signal NS2 to the transmission interface circuit 120.

The transmission interface circuit 120 may receive the neuron signal NS. To transmit information included in the neuron signal NS to the second neuron cluster 150, the transmission interface circuit 120 may perform an operation of processing the neuron signal NS, and may generate a transmission signal TS. The transmission interface circuit 120 may transmit the transmission signal TS to the router circuit 130. The transmission interface circuit 120 may receive a routing response ackRT from the router circuit 130. When receiving the routing response ackRT, the transmission interface circuit 120 may transmit the transmission response ackT to the first neuron cluster 110.

The router circuit 130 may receive the transmission signal TS. The router circuit 130 may perform an operation of selecting a communication path for transmitting information included in the transmission signal TS to the second neuron cluster 150 and may generate a routing signal RTS. The router circuit 130 may transmit the routing signal RTS to the reception interface circuit 140. The router circuit 130 may receive a reception response ackR from the reception interface circuit 140. When receiving the reception response ackR, the router circuit 130 may transmit the routing response ackRT to the transmission interface circuit 120.

The reception interface circuit 140 may receive the routing signal RTS. The reception interface circuit 140 may perform an operation of delivering information included in the routing signal RTS to the second neuron cluster 150 and may generate a reception signal RS. The reception interface circuit 140 may transmit the reception signal RS to the second neuron cluster 150. The reception interface circuit 140 may receive a neuron response ackN from the second neuron cluster 150. When receiving the neuron response ackN, the reception interface circuit 140 may transmit the reception response ackR to the router circuit 130.

The second neuron cluster 150 may receive the reception signal RS. When receiving the reception signal RS, the second neuron cluster 150 may transmit the neuron response ackN to the reception interface circuit 140. The neuron response ackN may include information for providing a notification that the second neuron cluster 150 has received data included in the neuron signal NS.

As mentioned above, the neuromorphic interface system 100 may be implemented by adopting an asynchronous method to minimize an error in signal transmission time and to consume less power.

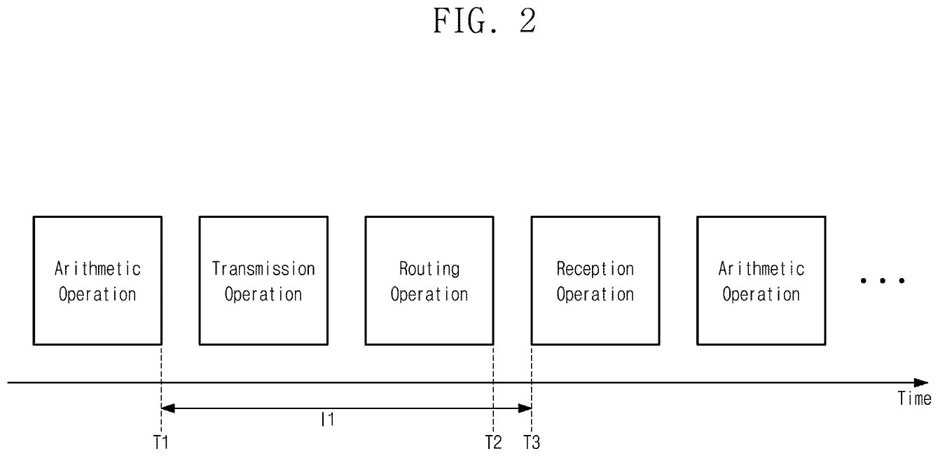

FIG. 2 is a diagram showing an operation flow of the neuromorphic interface system of FIG. 1. A horizontal axis of FIG. 2 represents a time. Referring to FIGS. 1 and 2, the first neuron cluster 110 may perform an arithmetic operation; the transmission interface circuit 120 may perform a transmission operation; the router circuit 130 may perform a routing operation; and, the reception interface circuit 140 may perform a reception operation.

For example, the arithmetic operation may mean an operation in which the first neuron cluster 110 described above generates the neuron signal NS. The transmission operation may refer to an operation in which the transmission interface circuit 120 described above generates the transmission signal TS. The routing operation may refer to an operation in which the router circuit 130 described above generates the routing signal RTS. The reception operation may refer to an operation in which the reception interface circuit 140 described above generates the reception signal RS.

Returning to FIG. 2, at a first time point T1, the first neuron cluster 110 may complete the arithmetic operation and may transmit the neuron signal NS to the transmission interface circuit 120. Afterward, the transmission interface circuit 120, the router circuit 130, and the reception interface circuit 140 may sequentially perform the transmission operation, the routing operation, and the reception operation.

At a second time point T2, the reception interface circuit 140 may complete the reception operation and may transmit the reception signal RS to the second neuron cluster 150.

After the second time point T2, the second neuron cluster 150 may transmit the neuron response ackN to the reception interface circuit 140. The reception interface circuit 140 may transmit the reception response ackR to the router circuit 130 in response to the neuron response ackN. The router circuit 130 may transmit the routing response ackRT to the transmission interface circuit 120 in response to the reception response ackR. The transmission interface circuit 120 may transmit the transmission response ackT to the first neuron cluster 110 in response to the routing response ackRT.

At a third time point T3, the first neuron cluster 110 may receive the transmission response ackT. Accordingly, the first neuron cluster 110 may recognize that data included in the neuron signal NS is delivered to the second neuron cluster 150. Accordingly, the first neuron cluster 110 may start performing an arithmetic operation for generating the next neuron signal NS.

As described above, during a time period Il until the third time point T3 at which the transmission response ackT is received after completing the arithmetic operation at the first time point T1, the first neuron cluster 110 may fail to perform an arithmetic operation of generating the next neuron signal NS and may need to wait. Accordingly, interface circuits (e.g., 120 to 140) of the neuromorphic interface system 100 may cause a delay when delivering the generated information from the first neuron cluster 110 to the second neuron cluster 150. Accordingly, the neuromorphic interface system 100 may fail to operate at high speed.

For example, the first neuron cluster 110 and the second neuron cluster 150 may be spike-based neuromorphic circuits. As mentioned above, when the delay occurs due to the interface circuits in a neuromorphic interface system including a spike-based neuromorphic circuit, an error may occur in the calculation result of the neuromorphic circuit.

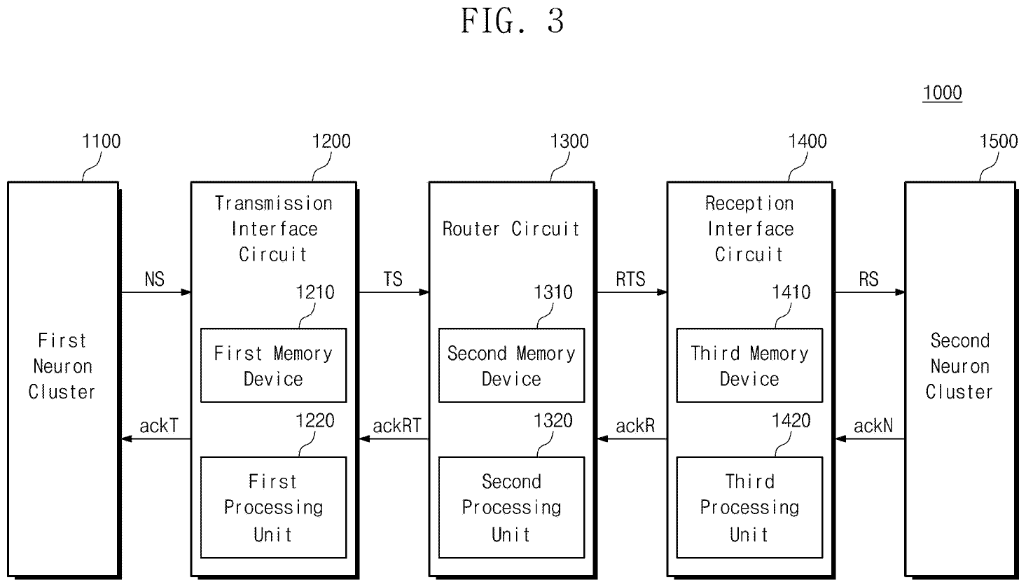

FIG. 3 is a diagram showing a neuromorphic interface system, according to an embodiment of the present disclosure. Referring to FIG. 3, a neuromorphic interface system 1000 may include a first neuron cluster 1100, a transmission interface circuit 1200, a router circuit 1300, a reception interface circuit 1400, and a second neuron cluster 1500.

In an embodiment, the neuromorphic interface system 1000 may be implemented by adopting an asynchronous method to minimize an error in signal transmission time and to consume less power.

The first neuron cluster 1100, the transmission interface circuit 1200, the router circuit 1300, the reception interface circuit 1400, and the second neuron cluster 1500 may operate similarly to the first neuron cluster 110, the transmission interface circuit 120, the router circuit 130, the reception interface circuit 140, and the second neuron cluster 150 of FIG. 1.

In detail, the first neuron cluster 1100 may generate the neuron signal NS by performing an arithmetic operation; the transmission interface circuit 1200 may generate the transmission signal TS by performing a transmission operation; the router circuit 1300 may generate the routing signal RTS by performing a routing operation; and, the reception interface circuit 1400 may generate the reception signal RS by performing a reception operation. Hereinafter, a difference between the neuromorphic interface system 100 of FIG. 1 and the neuromorphic interface system 1000 of FIG. 3 will be mainly described.

The transmission interface circuit 1200 may include a first memory device 1210 and a first processing unit 1220. The transmission interface circuit 1200 may store neuron data (not shown), which is included in the neuron signal NS, in the first memory device 1210.

To transmit the neuron data included in the neuron signal NS to the second neuron cluster 1500, the first processing unit 1220 may perform an operation of processing the neuron signal NS. The first processing unit 1220 may output the transmission signal TS.

Regardless of whether an operation of the first processing unit 1220 has ended, the transmission interface circuit 1200 may transmit the transmission response ackT to the first neuron cluster 1100 as soon as the neuron data is stored in the first memory device 1210.

When the first neuron cluster 1100 receives the transmission response ackT, the first neuron cluster 1100 may perform an operation of generating the next neuron signal NS regardless of whether data included in the neuron signal NS is delivered to the second neuron cluster 1500.

For example, the first neuron cluster 1100 may transmit the first neuron signal NS1 to the transmission interface circuit 1200 and then may receive a first transmission response (e.g., ackT1). In this case, regardless of whether data included in the first neuron signal NS1 is delivered to the second neuron cluster 1500, the first neuron cluster 1100 may perform an operation of generating the second neuron signal NS2 following the first neuron signal NS1.

In other words, after transmitting the first neuron signal NS1, the first neuron cluster 1100 may perform an operation of generating the second neuron signal NS2 based on the first transmission response ackT1, regardless of whether operations of the interface circuits 1200 to 1400 are completed.

The router circuit 1300 may include a second memory device 1310 and a second processing unit 1320. The router circuit 1300 may store transmission data (not shown), which is included in the transmission signal TS, in the second memory device 1310.

The second processing unit 1320 may perform an operation of selecting a path for transmitting data included in the transmission signal TS to the second neuron cluster 1500. The second processing unit 1320 may output the routing signal RTS.

Regardless of whether an operation of the second processing unit 1320 has ended, the router circuit 1300 may transmit the routing response ackRT to the transmission interface circuit 1200 as soon as the transmission data is stored in the second memory device 1310.

When receiving the routing response ackRT, the transmission interface circuit 1200 may perform a routing operation of generating the next transmission signal TS regardless of whether data included in the transmission signal TS is delivered to the second neuron cluster 1500.

The reception interface circuit 1400 may include a third memory device 1410 and a third processing unit 1420. The reception interface circuit 1400 may store routing data (not shown), which is included in the routing signal RTS, in the third memory device 1410.

The third processing unit 1420 of the reception interface circuit 1400 may perform an operation of delivering information included in the routing signal RTS to the second neuron cluster 1500. The third processing unit 1420 may output the reception signal RS. For example, the reception signal RS may include reception data (not shown).

Regardless of whether an operation of the third processing unit 1420 has ended, the reception interface circuit 1400 may transmit the reception response ackR to the router circuit 1300 as soon as the routing data is stored in the third memory device 1410.

When receiving the reception response ackR, the router circuit 1300 may perform a routing operation of generating the next routing signal RTS regardless of whether the information included in the routing signal RTS is delivered to the second neuron cluster 1500.

The second neuron cluster 1500 may receive the reception signal RS. The second neuron cluster 1500 may transmit the neuron response ackN to the reception interface circuit 1400 in response to the reception signal RS. The reception interface circuit 1400 may perform a reception operation of generating the next reception signal RS based on the neuron response ackN.

In an embodiment, each of the first, second, and third memory devices 1210, 1310, and 1410 may include volatile memories such as SRAM and/or DRAM, and may also include non-volatile memories such as a flash memory, PRAM and/or RRAM.

In an embodiment, the reception data may include routing data; the routing data may include transmission data; and, the transmission data may include neuron data. Accordingly, the first neuron cluster 1100 may transmit neuron data to the second neuron cluster 1500 through the interface circuits 1200 to 1400.

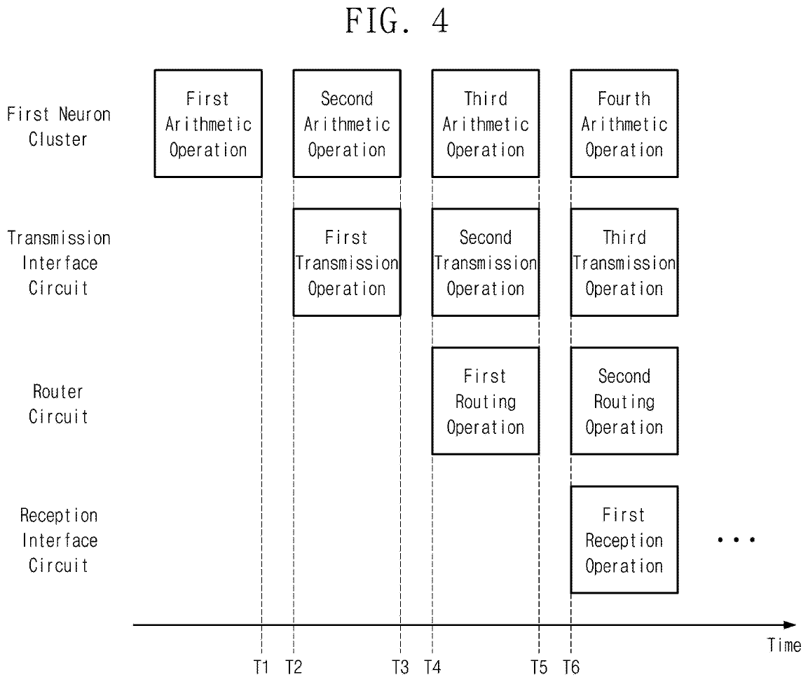

FIG. 4 is a diagram showing an operation flow of the neuromorphic interface system of FIG. 3. In FIG. 4, a horizontal axis represents a time, and a vertical axis represents the subject of an operation. Referring to FIGS. 3 and 4, at a first time point, the first neuron cluster 1100 may terminate a first arithmetic operation and may transmit the first neuron signal NS1 to the transmission interface circuit 1200.

After the first time point, the transmission interface circuit 1200 may store first neuron data, which is included in the first neuron signal NS1, in the first memory device 1210 and may transmit the first transmission response ackT1 to the first neuron cluster 1100.

At a second time point, the first neuron cluster 1100 may start a second arithmetic operation of generating the second neuron signal NS2 in response to the first transmission response ackT1. The transmission interface circuit 1200 may perform a first transmission operation of generating a first transmission signal TS1 based on the first neuron signal NS1.

In other words, there is no need to wait for a response including information that the data included in the first neuron signal has been delivered to the second neuron cluster 1500, and thus the first neuron cluster 1100 may start a second arithmetic operation in response to the first transmission response ackT1.

At a third time point, the first neuron cluster 1100 may transmit the second neuron signal NS2 to the transmission interface circuit 1200. The transmission interface circuit 1200 may transmit the first transmission signal TS1 to the router circuit 1300.

After the third time point, the transmission interface circuit 1200 may store second neuron data, which is included in the second neuron signal NS2, in the first memory device 1210 and may transmit a second transmission response signal ackT2 to the first neuron cluster 1100. The router circuit 1300 may store first transmission data, which is included in the first transmission signal TS1, in the second memory device 1310 and may transmit a first routing response signal ackRT1 to the transmission interface circuit 1200.

At a fourth time point, the first neuron cluster 1100 may start a third arithmetic operation in response to a second transmission response ackT2. The transmission interface circuit 1200 may start a second transmission operation in response to a first routing response signal ackRT. The router circuit 1300 may start a first routing operation in response to the first transmission signal TS1.

At a fifth time point, the first neuron cluster 1100 may transmit a third neuron signal NS3 to the transmission interface circuit 1200. The transmission interface circuit 1200 may transmit a second transmission signal TS2 to the router circuit 1300. The router circuit 1300 may transmit the first routing signal RTS to the reception interface circuit 1400.

After the fifth time point, the transmission interface circuit 1200 may store third neuron data, which is included in the third neuron signal NS3, in the first memory device 1210 and may transmit a third transmission response signal ackT3 to the first neuron cluster 1100. The router circuit 1300 may store second transmission data, which is included in the second transmission signal TS2, in the second memory device 1310 and may transmit a second routing response signal ackRT2 to the transmission interface circuit 1200. The reception interface circuit 1400 may store first routing data, which is included in the first routing signal RTS, in the third memory device 1410 and may transmit a first reception response signal ackR1 to the router circuit 1300.

At a sixth time point, the first neuron cluster 1100 may start a fourth arithmetic operation in response to a third transmission response ackT3. The transmission interface circuit 1200 may start a third transmission operation in response to a second routing response signal ackRT. The router circuit 1300 may start a second routing operation in response to a first reception response signal ackR.

As mentioned above, the neuromorphic interface system 1000 according to an embodiment of the present disclosure is implemented such that the interface circuits 1200 to 1400 respectively include the memory devices 1210, 1310, and 1410. Accordingly, a memory-based parallel pipeline interface system may be implemented.

In detail, the transmission interface circuit 1200, the router circuit 1300, and the reception interface circuit 1400, which performs different operations from one another, are implemented to include the memory devices 1210, 1310, and 1410, respectively and may process an input signal based on a response signal (e.g., the transmission response signal ackT) indicating that data has been stored in a memory transmitted in the next stage. Accordingly, each of the components 1100 to 1500 of the neuromorphic interface system 1000 may continuously operate without waiting until the entire operation of the neuromorphic interface system 1000 is ended. Accordingly, a delay caused by the interface circuits 1200 to 1400 of the neuromorphic interface system 1000 of FIG. 3 may be smaller than that of the neuromorphic interface system 100 of FIG. 1. Accordingly, the neuromorphic interface system 1000 of FIG. 3 may operate at higher speed than the neuromorphic interface system 100 of FIG. 1.

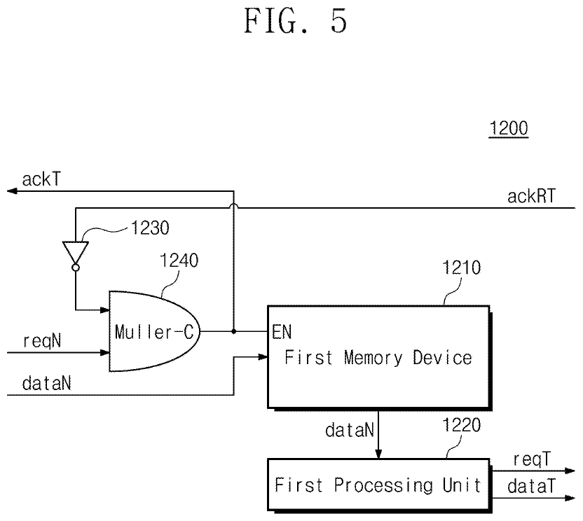

FIG. 5 is a circuit diagram for describing an example of a part of the transmission interface circuit of FIG. 3. For convenience and conciseness of illustration, in FIG. 5, only a part of the transmission interface circuit 1200 of FIG. 3 is described. However, the router circuit 1300 and the reception interface circuit 1400 of FIG. 3 may include a circuit having the same structure as the circuit shown in FIG. 5. FIG. 5 will be described with reference to FIG. 3.

Referring to FIG. 5, the transmission interface circuit 1200 may include the first memory device 1210, the first processing unit 1220, an inverter element 1230, and a muller-C element 1240.

The transmission interface circuit 1200 may receive the neuron signal NS from the first neuron cluster 1100. The neuron signal NS may include a neuron request reqN and neuron data dataN.

The first memory device 1210 may receive the neuron data dataN and a transmission response signal ackT. The first memory device 1210 may be enabled based on the transmission response signal ackT. When the first memory device 1210 is enabled, the neuron data dataN may be stored in the first memory device 1210. The first memory device 1210 may transmit the stored neuron data dataN to the first processing unit 1220.

The first processing unit 1220 may perform an operation based on the neuron data dataN. The first processing unit 1220 may output the transmission signal TS. The transmission signal TS may include a transmission request reqT and transmission data dataT. For example, the transmission request reqT may be transmitted to a muller-C element included in the router circuit 1300, and the transmission data dataT may be transmitted to the second memory device 1310 included in the router circuit 1300.

The inverter element 1230 may receive the routing response ackRT from the router circuit 1300. An output signal of the inverter element 1230 may be input to the muller-C element 1240.

The muller-C element 1240 may receive the inverted routing response and the neuron request reqN. The muller-C element 1240 may output the transmission response ackT. Accordingly, on the basis of the state of the router circuit 1300, the transmission interface circuit 1200 may determine whether to store the neuron data dataN in the first memory device 1210.

For example, when all of the input signals are logic high or logic low, the muller-C element 1240 may be designed to output logic 1 or logic 0. When the input signals are different from each other, the muller-C element 1240 may be designed to keep a previous output signal value.

In an embodiment, on the basis of the state of the router circuit 1300, the transmission interface circuit 1200 may determine whether to store the neuron data dataN in a first memory device. Accordingly, only when the operation of the second processing unit 1320 is ended, the transmission interface circuit 1200 may store the neuron data dataN in the first memory device.

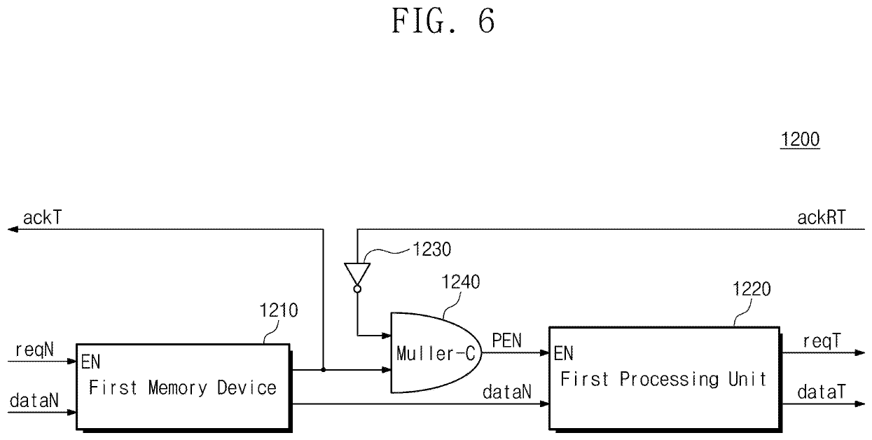

FIG. 6 is a circuit diagram for describing another example of a part of the transmission interface circuit of FIG. 3. For convenience and conciseness of illustration, in FIG. 6, only a part of the transmission interface circuit 1200 of FIG. 3 is described. However, the router circuit 1300 and the reception interface circuit 1400 of FIG. 3 may include a circuit having the same structure as the circuit shown in FIG. 6. FIG. 6 will be described with reference to FIG. 3.

Referring to FIG. 6, the transmission interface circuit 1200 may include the first memory device 1210, the first processing unit 1220, the inverter element 1230, and the muller-C element 1240.

The transmission interface circuit 1200 may receive the neuron signal NS from the first neuron cluster 1100. The neuron signal NS may include a neuron request reqN and neuron data dataN.

The first memory device 1210 may receive the neuron data dataN and the neuron request reqN. The first memory device 1210 may be enabled based on the neuron request reqN. When the first memory device 1210 is enabled, the neuron data dataN may be stored in the first memory device 1210.

The first memory device 1210 may transmit the transmission response ackT to the first neuron cluster 1100 and the muller-C element 1240 through a first output terminal. The first memory device 1210 may transmit the stored neuron data dataN to the first processing unit 1220 through a second output terminal.

The first processing unit 1220 may be connected to an output terminal of the muller-C element. The first processing unit 1220 may be enabled based on a processing enable signal PEN. When the first processing unit 1220 is enabled, the first processing unit 1220 may output the transmission signal TS by performing an operation based on the neuron data dataN. The transmission signal TS may include a transmission request reqT and transmission data dataT. For example, the transmission request reqT and the transmission data dataT may be transmitted to the second memory device 1310 included in the router circuit 1300.

The inverter element 1230 may receive the routing response ackRT from the router circuit 1300 and may output an inverted routing response obtained by inverting the routing response ackRT.

The muller-C element 1240 may be connected to an output terminal of the inverter element 1230 and the first output terminal of the first memory device. The muller-C element 1240 may output a processing enable signal PEN based on the inverted routing response and the transmission response ackT. The first processing unit 1220 may be enabled based on the processing enable signal PEN. That is, whether the first processing unit 1220 is enabled may be determined based on the state of the router circuit 1300.

Unlike the case of FIG. 5, regardless of whether an operation of the second processing unit 1320 is ended, the transmission interface circuit 1200 of FIG. 6 may store the neuron data dataN in the first memory device 1210 once and may transmit the transmission response ackT to the first neuron cluster 1100. Accordingly, regardless of whether the operation of the second processing unit 1320 is ended, the first neuron cluster 1100 may perform an arithmetic operation of generating the next neuron signal NS.

In other words, the transmission interface circuit 1200 of FIG. 5 generates the transmission response ackT based on the state of the router circuit 1300. On the other hand, the transmission interface circuit 1200 of FIG. 6 first stores the neuron data dataN and transmits the transmission response ackT regardless of the state of the router circuit 1300. Accordingly, the transmission interface circuit 1200 of FIG. 6 may operate at a higher speed than the transmission interface circuit 1200 of FIG. 5.

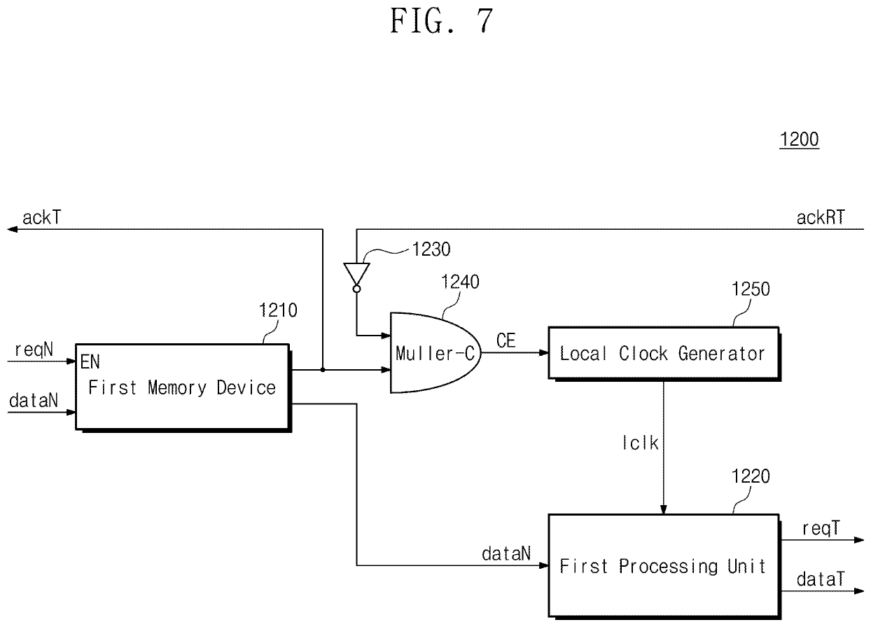

FIG. 7 is a circuit diagram for describing another example of a part of the transmission interface circuit of FIG. 6. For convenience and conciseness of illustration, in FIG. 7, only a part of the transmission interface circuit 1200 of FIG. 3 is described. However, the router circuit 1300 and the reception interface circuit 1400 of FIG. 3 may include a circuit having the same structure as the circuit shown in FIG. 7. FIG. 7 will be described with reference to FIGS. 3 and 6.

Referring to FIG. 7, the transmission interface circuit 1200 may include the first memory device 1210, the first processing unit 1220, the inverter element 1230, the muller-C element 1240, and a local clock generator 1250. Operations of the first memory device 1210, the first processing unit 1220, the inverter element 1230, and the muller-C element 1240 are similar to those described above with reference to FIG. 6. Hereinafter, a difference between the transmission interface circuit 1200 of FIG. 7 and the transmission interface circuit 1200 of FIG. 6 will be mainly described.

As described above, the neuromorphic interface system 1000 may be implemented by adopting an asynchronous method to minimize an error in signal transmission time and to consume less power. However, in the first processing unit 1220 of the transmission interface circuit 1200, the second processing unit 1320 of the router circuit 1300, and the third processing unit 1420 of the reception interface circuit 1400, an arithmetic operation for processing input data may be complex. When all components of the neuromorphic interface system 1000 operate in an asynchronous manner, it may be difficult for each of the processing units 1220, 1320, and 1420 of the interface circuits 1200, 1300, and 1400 to perform complex calculations.

Accordingly, to easily process data of the processing units 1220, 1320, and 1420, the neuromorphic interface system 1000 may be implemented as a globally asynchronous locally synchronous (GALS) system. Accordingly, some components of the neuromorphic interface system 1000 may operate based on a local clock. To this end, each of the interface circuits 1200 to 1400 may include a local clock generator (e.g., 1250).

Returning to FIG. 7, the muller-C element 1240 may generate the clock enable signal CE based on the inverted routing response and the transmission response ackT. The clock enable signal CE may be transmitted to the local clock generator 1250.

The local clock generator 1250 may be connected to the output terminal of the muller-C element 1240. The local clock generator 1250 may generate a local clock lclk based on the clock enable signal CE.

The first processing unit 1220 may be connected to an output terminal of the local clock generator 1250 and the second output terminal of the first memory device 1210. The first processing unit 1220 may receive the local clock lclk and the neuron data dataN. When receiving the local clock lclk, the first processing unit 1220 may output the transmission signal TS by performing an operation based on the neuron data dataN. The transmission signal TS may include a transmission request reqT and transmission data dataT. For example, the transmission request reqT and the transmission data dataT may be transmitted to the second memory device 1310 included in the router circuit 1300.

Because the first processing unit 1220 of FIG. 7 operates based on the local clock lclk, the first processing unit 1220 of FIG. 7 may process the neuron data dataN by performing a more complex operation than in the case of FIG. 6.

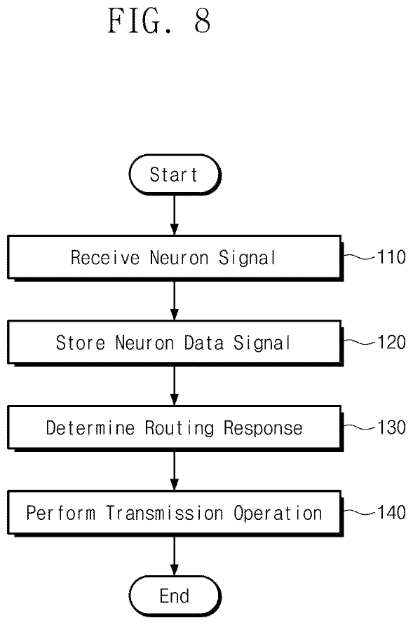

FIG. 8 is a circuit diagram for describing another example of a part of the transmission interface circuit of FIG. 5. For convenience and conciseness of illustration, in FIG. 8, only a part of the transmission interface circuit 1200 of FIG. 3 is described. However, the router circuit 1300 and the reception interface circuit 1400 of FIG. 3 may include a circuit having the same structure as the circuit shown in FIG. 8. FIG. 8 will be described with reference to FIGS. 3 and 5.

Referring to FIG. 8, the transmission interface circuit 1200 may include the first memory device 1210, the first processing unit 1220, the inverter element 1230, the muller-C element 1240, and the local clock generator 1250. Operations of the first memory device 1210, the first processing unit 1220, the inverter element 1230, and the muller-C element 1240 are similar to those described above with reference to FIG. 5. Hereinafter, a difference between the transmission interface circuit 1200 of FIG. 8 and the transmission interface circuit 1200 of FIG. 5 will be mainly described.

As described with reference to FIG. 7, FIG. 8 shows the neuromorphic interface system 1000 that has a similar structure to the transmission interface circuit 1200 of FIG. 5 and is implemented as a GALS system.

Referring to FIG. 8, the muller-C element 1240 may generate the clock enable signal CE based on the inverted routing response and the neuron request reqN. The clock enable signal CE may be transmitted to the local clock generator 1250.

The local clock generator 1250 may be connected to the output terminal of the muller-C element 1240. The local clock generator 1250 may generate a local clock lclk based on the clock enable signal CE.

The first processing unit 1220 may be connected to an output terminal of the local clock generator 1250. The first processing unit 1220 may receive the local clock lclk and the neuron data dataN. When receiving the local clock lclk, the first processing unit 1220 may output the transmission signal TS by performing an operation based on the neuron data dataN. The transmission signal TS may include a transmission request reqT and transmission data dataT. For example, the transmission request reqT and the transmission data dataT may be transmitted to the second memory device 1310 included in the router circuit 1300.

Because the first processing unit 1220 of FIG. 8 operates based on the local clock lclk, as in the case of FIG. 7, the first processing unit 1220 of FIG. 7 may process the neuron data dataN by performing a more complex operation than in the case of FIG. 5.

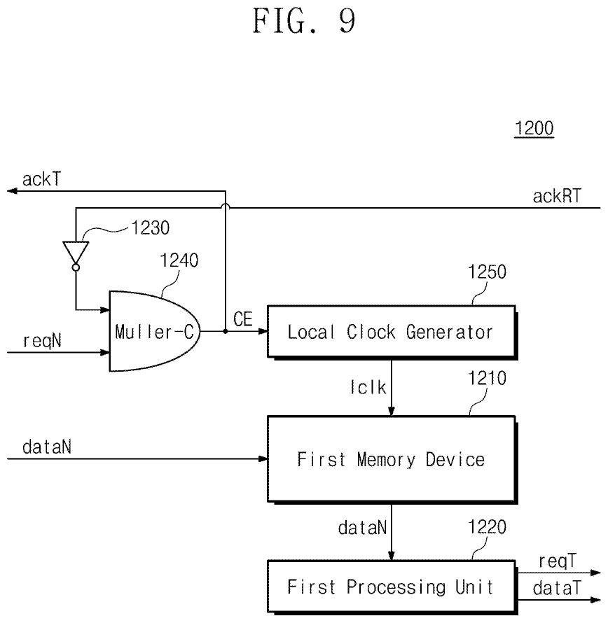

FIG. 9 is a flowchart illustrating an operating method of a neuromorphic interface circuit, according to an embodiment of the present disclosure. FIG. 9 will be described with reference to FIGS. 3 and 6. For brevity of drawing and for convenience of description, in FIG. 9, an operating method of the transmission interface circuit 1200 of FIG. 3 is described. However, the router circuit 1300 and the reception interface circuit 1400 of FIG. 3 may also operate similarly to the transmission interface circuit 1200.

In operation S110, the transmission interface circuit 1200 may receive the neuron signal NS. In this case, the neuron signal NS may include the neuron request reqN and the neuron data dataN.

In operation S120, the transmission interface circuit 1200 may store the neuron data dataN in the first memory device 1210. As soon as the transmission interface circuit 1200 stores the neuron data dataN in the first memory device 1210, the transmission interface circuit 1200 may transmit the transmission response ackT to the first neuron cluster 1100. Regardless of whether the transmission operation based on the neuron signal NS is ended, the transmission interface circuit 1200 may transmit the transmission response ackT to the first neuron cluster 1100.

In operation S130, the transmission interface circuit 1200 may determine whether to perform an operation of generating a transmission signal RT, based on the routing response ackRT.

In operation S140, the transmission interface circuit 1200 may generate the transmission signal RT and may transmit the transmission signal RT to the router circuit 1300.

The above description refers to embodiments for implementing the present disclosure. Embodiments in which a design is changed simply or which are easily changed may be included in the present disclosure as well as an embodiment described above. In addition, technologies that are easily changed and implemented by using the above embodiments may be included in the present disclosure. While the present disclosure has been described with reference to embodiments thereof, it will be apparent to those of ordinary skill in the art that various changes and modifications may be made thereto without departing from the spirit and scope of the present disclosure as set forth in the following claims.

According to an embodiment of the present disclosure, a parallel pipeline interface system may be implemented by using a neuromorphic interface system in which each interface circuit includes a memory device. Accordingly, it is possible to provide a neuromorphic interface circuit that consumes low power and operates at high speed, an operating method thereof, and a neuromorphic interface system.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A neuromorphic interface system, the system comprising:
a first neuron cluster configured to output a first neuron signal including a first neuron request and first neuron data by performing a first arithmetic operation; and
a first interface circuit configured to store the first neuron data and to output a first response, in response to the first neuron request,
wherein, the first neuron cluster is configured to output a second neuron signal including a second neuron request and second neuron data by performing a second arithmetic operation, in response to the first response, and
wherein, before the first data is transmitted to a second neuron cluster different from the first neuron cluster, the first interface circuit outputs the first response based on a fact that the first neuron data is stored.

2. The system of claim 1, wherein the first interface circuit is further configured to:
output a first transmission signal including a first transmission request and first transmission data by performing a first transmission operation; and
after outputting the first response, output the first transmission signal.

3. The system of claim 2, wherein the first neuron cluster includes a plurality of neuron circuits and a plurality of synaptic circuits, and
wherein the first neuron signal is a signal generated as a first neuron circuit among the plurality of neuron circuits fires.

4. The system of claim 2, wherein the first interface circuit includes a first memory device,
wherein the first memory device is enabled based on the first neuron request, and
wherein, when the first memory device is enabled, the first neuron data is stored in the first memory device.

5. The system of claim 4, further comprising:
a second interface circuit configured to store the first transmission data and to output a second response, in response to the first transmission request,
wherein the first interface circuit is configured to output a second transmission signal including a second transmission request and second transmission data by performing a second transmission operation, in response to the second response, and
wherein, before the first transmission data is transmitted to the second neuron cluster, the second interface circuit outputs the second response in response to a fact that the first transmission data is stored.

6. The system of claim 5, wherein the second interface circuit is further configured to:
output a first routing signal including a first routing request and first routing data by performing a first routing operation; and
after outputting the second response, output the first routing signal.

7. The system of claim 6, wherein the second interface circuit further includes a second memory device,
wherein the second memory device is enabled based on the first transmission request, and
wherein, when the second memory device is enabled, the first transmission data is stored in the second memory device.

8. The system of claim 7, further comprising:
a third interface circuit configured to store the first routing data and to output a third response, in response to the first routing request,
wherein the second interface circuit is configured to output a second routing signal including a second routing request and second routing data by performing a second routing operation, in response to the third response, and
wherein, before the first routing data is transmitted to the second neuron cluster, the third interface circuit outputs the third response in response to a fact that the first routing data is stored.

9. The system of claim 8, wherein the third interface circuit is further configured to:
output a first reception signal including a first reception request and first reception data by performing a first reception operation; and
after outputting the third response, output the first reception signal.

10. The system of claim 9, wherein the third interface circuit includes a third memory device,
wherein the third memory device is enabled based on the first routing request, and
wherein, when the third memory device is enabled, the first routing data is stored in the third memory device.

11. The system of claim 10, wherein the first interface circuit is a transmission interface circuit for delivering information included in the first neuron signal to the second neuron cluster,
wherein the second interface circuit is a router circuit for selecting a path for delivering the information included in the first neuron signal to the second neuron cluster, and
wherein the third interface circuit is a reception interface circuit that receives the information included in the first neuron signal and delivers the information to the second neuron cluster.

12. The system of claim 11, wherein each of the first to third interface circuits operates in an asynchronous manner.

13. An interface circuit configured to receive a first input signal including a first request and first input data from a first circuit and to transmit an output signal to a second circuit, the interface circuit comprising:
a memory device configured to store first input data included in the first input signal, and to output a first response for requesting a second input signal following the first input signal to the first circuit; and
a processing unit configured to generate the output signal based on the first input data stored in the memory device and a second response transmitted from the second circuit,
wherein, before the output signal is generated, the memory device is further configured to output the first response.

14. The interface circuit of claim 13, further comprising:
an inverter element configured to receive the second response and to output an inverted second response obtained by inverting the second response; and
a muller-C element connected to an output terminal of the inverter element and a first output terminal of the memory device and configured to output a processing enable signal based on the first response and the inverted second response,
wherein the memory device is further configured to:
transmit the first response to the first circuit and the muller-C element through the first output terminal; and
transmit the first input data thus stored, to the processing unit through a second output terminal, and
wherein the processing unit is connected to an output terminal of the muller-C element and the second output terminal of the memory device, and is enabled based on the processing enable signal to generate the output signal.

15. The interface circuit of claim 13, further comprising:
an inverter element configured to receive a second response from the second circuit and to output an inverted second response obtained by inverting the second response;
a muller-C element connected to an output terminal of the inverter element and a first output terminal of the memory device and configured to output a clock enable signal based on the first response and the inverted second response; and
a local clock generator connected to an output terminal of the muller-C element and configured to output a local clock signal based on the clock enable signal,
wherein the memory device is further configured to:
transmit the first response to the first circuit and the muller-C element through the first output terminal; and
transmit the first input data thus stored, to the processing unit through a second output terminal, and
wherein the processing unit is connected to an output terminal of the local clock generator and the second output terminal of the memory device and is further configured to output the output signal based on the local clock signal.

16. An operating method of an interface circuit including a memory device and configured to mediate communication between a first circuit and a second circuit, the method comprising:
receiving a first input signal from the first circuit;
storing input data, which is included in the first input signal, in the memory device and transmitting a first response to the first circuit;
determining a state of the second circuit based on a second response transmitted from the second circuit; and
generating an output signal based on the state of the second circuit.

17. The method of claim 16, wherein the first circuit includes at least one neuron circuit, and
wherein the first input signal is a signal generated as a first neuron circuit among the at least one neuron circuit fires.

18. The method of claim 17, wherein the first response is a signal for requesting the first circuit to generate a second input signal following the first input signal.
